(19) United States
(12) Patent Application Publication
(10) Pub. No.: US 2011/0199771 A1
(43) Pub. Date: Aug. 18, 2011

(54) THERMAL MANAGEMENT KIT FOR HIGH POWER SOLID STATE LIGHT EMITTING DIODES

(76) Inventor: Lu Vinh Luu, Irvine, CA (US)

(21) Appl. No.: 12/994,706

(22) PCT Filed: Sep. 15, 2010
(86) PCT No.: PCT/IB10/02358

§ 371 Date: Nov. 24, 2010

(30) Foreign Application Priority Data
Sep. 22, 2009 (TH) 0901004256

(51) Int. Cl. F21V 29/00

(52) U.S. Cl. 362/294

(57) ABSTRACT

The thermal management kit for high power of solid state light emitting diodes is invented to use the opened channel and/or hole of exiting luminaire and/or made a new hole and/or holes of upper luminaire and/or any part. The present invention utilize the hole in order to dissipative inside heat to outside of luminaire by using function of heat pipes by set up the heat pipe passes through opened channel and/or hole of luminaire.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

High power luminaire of solid state LEDs which generates high intensity light and heat more than general high power light bulb, but power consumed is three times less than. in specially of closed luminaire, the internal cumulative heats continuously within closed chamber which the cumulative heats cannot transfer to external faster or continuously. Therefore, the present invention to make an opened channel and/or hole of closed luminaire, by using the invention to manage dissipative heats as continuously and efficiency to the opened hole.

Refer FIG. 1 , is model of heat dissipative of closed system, consist of heat source which attached to heat absorb-transfer plate, and heat pipes passes though the opened hole to external, by using function of heat pipes to transfer heats out to condensation of heat sink fins which located at external of system. Inside of the closed system, if heat source generated and cumulative heat too high, such as solid state LEDs which generated too much heats if cannot fast dissipative and unbalance heat, will effect to make solid state LEDs degrade and shorter self life than specification. The present invention, apply the opened channel and/or make a hole and/or make holes of upper and/or any part of luminaire.

### BRIEF SUMMARY

The present invention is related to dissipative heat system kit for high power lighting luminaire of solid state LEDs. The kit consist of solid state LEDs as heat source, which is connected to external by heat pipes in order to release inside heat of closed luminaire to external environment continuously and extend shelf life cycle of high power luminaire of solid state LEDs. The present invention consists of heat absorb dissipative from heat source, heat pipes, condensation of heat sink fins, and most important of the invention is the opened channel and/or hole of exiting luminaire and/or make a new hole and/or make holes of upper luminaire or any part of luminaire. The opened hole luminaire of the invention use for heat pipes passes in order to dissipative heat from internal to external of luminaire continuously. The purpose of this invention, is heat dissipative system of high power luminaire, also help to dissipative heat continuously in order to reduce inside heat cumulative luminaire and extend life cycle of solid state LEDs.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is heat dissipative diagram model of closed system from internal to external by heat pipes functional;

FIG. 1A is thermal management kit to manage heat dissipative passes hole of closed system to external by connected heat pipes between heat absorber and condensation of fin heat sink;

FIG. 2 is commercial closed luminaire which installed as road side and/or parking area FIG. 3 is upper side of closed luminaire;

FIG. 4 is opened channel and/or hole on upper closed luminaire with a hole and/or make more than a hole of several model;

FIG. 4A is inside luminaire which do not have opened hole and make a hole and/or more holes of variety model;

FIG. 5 is thermal management kit of the invention;

FIG. 5A is thermal management kit of high power watt solid state LEDs;

FIG. 6 is assembled thermal management system of the invention to upper luminaire;

FIG. 6A is assembled of the invention by heat sink direction aim to back of luminaire FIG. 6B is assembled of the invention by heat sink direction aim to front of luminaire FIG. 6C is cross section of the invention;

FIG. 7 is the invention which assembled direct fixed to heat pipes;

FIG. 8 is the invention which direct fixed the heat pipes to the hole of luminaire;

FIG. 9 is the invention which bent the heat pipes;

FIG. 10 is the invention which bent the hat pipes passes to the hole of upper luminaire FIG. 11 is cross section of the invention; and

FIG. 12 is cross section of the invention;

### DETAILED DESCRIPTION

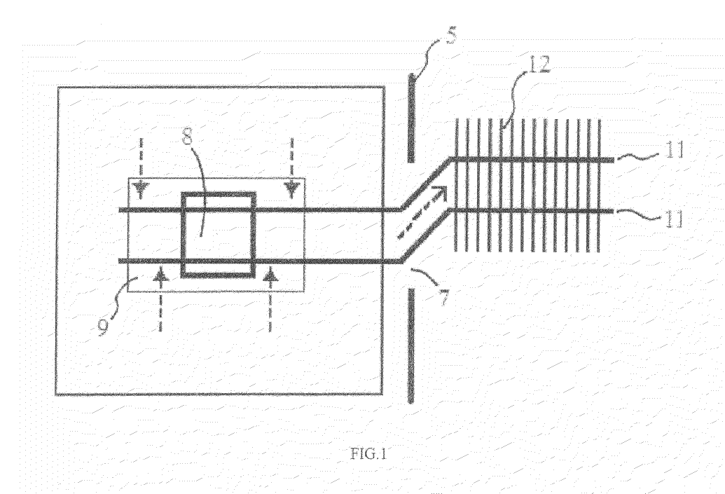

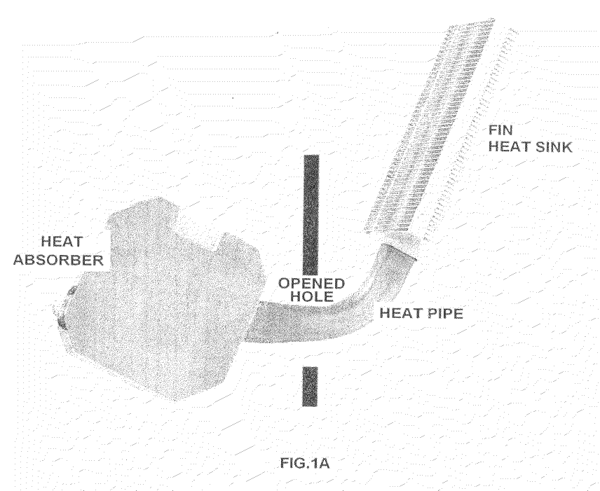

The present invention use natural convention of heat dissipative, as FIG. 1 show diagram model of heat dissipative o closed system, consist of heat source attached with heat absorber to dissipative heats, and heat pipes passes through external, in order to transfer heats via heat condensation heat sink out to external. The present invention is designed to comprise as structure and characteristics of luminaire.

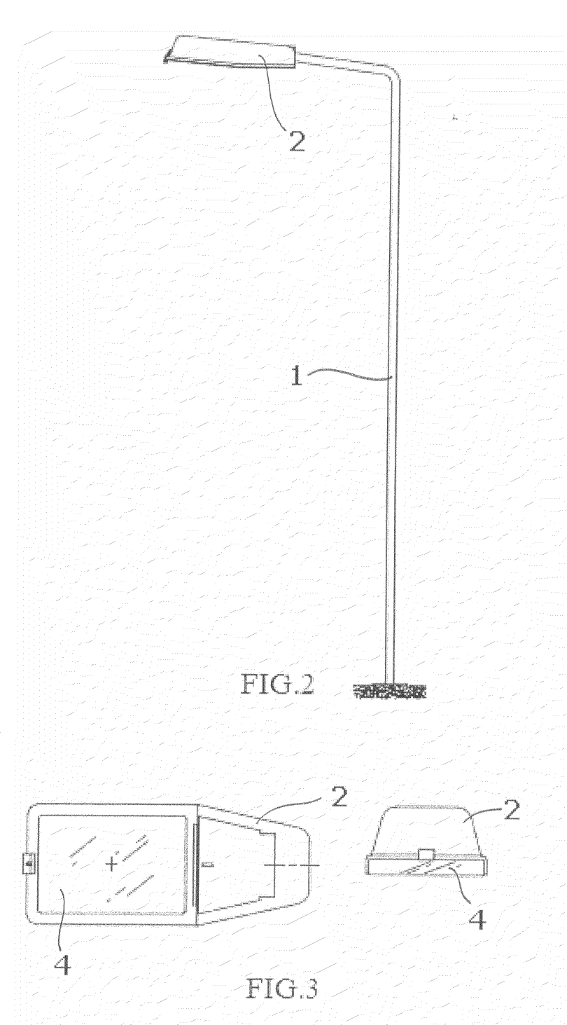

The present invention is used to fabricate with opened channel and/or hole (7) of upper luminaire as FIG. 4, which indicated closed system of luminaire (2), as is defined the middle position of luminaire (6) for reference to make opened channel and/or hole. Comparison of luminaire with exiting hole (5) and/or make opened channel and/or new hole (7) and/or make holes in several positions.

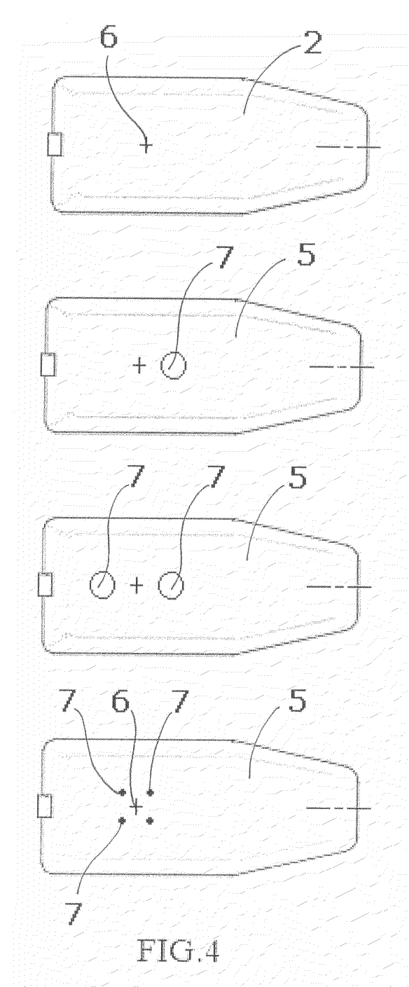

The complete set of present invention as FIG. 5, show heat dissipative system of high power luminaire of solid state LEDs consist of solid state LEDs (3) which is fixed to heat absorber (9), solid state LEDs (8) is coverage with reflector (3).

The heat absorber (9) which is extruded to have rails as heat pipes (11) quantity, which can be assembly or disassembly, by the other end of heat pipe (II) is fixed with condensation of heat sink fins (12), and coverage cap of fixed hole part (10), is function to fix heat pipes (11) with opened channel and/or hole (7).

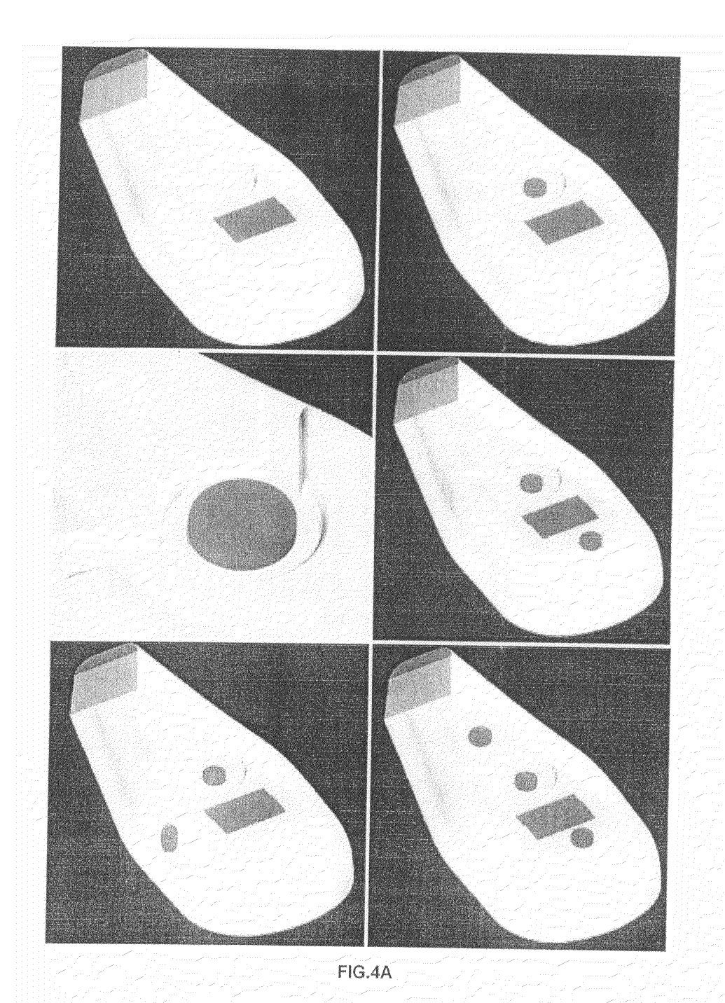

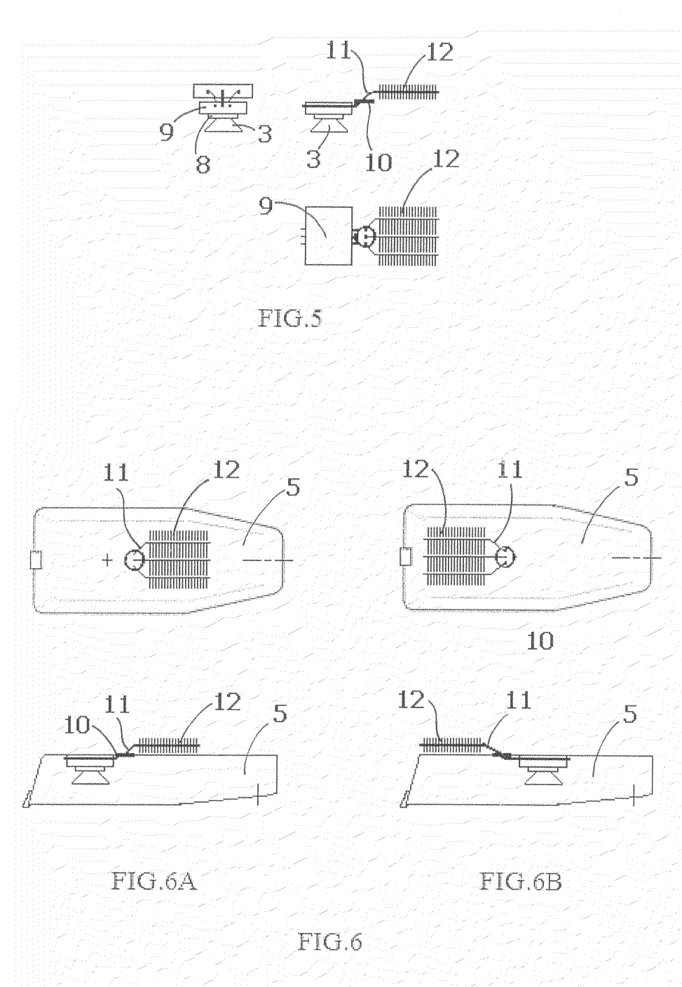

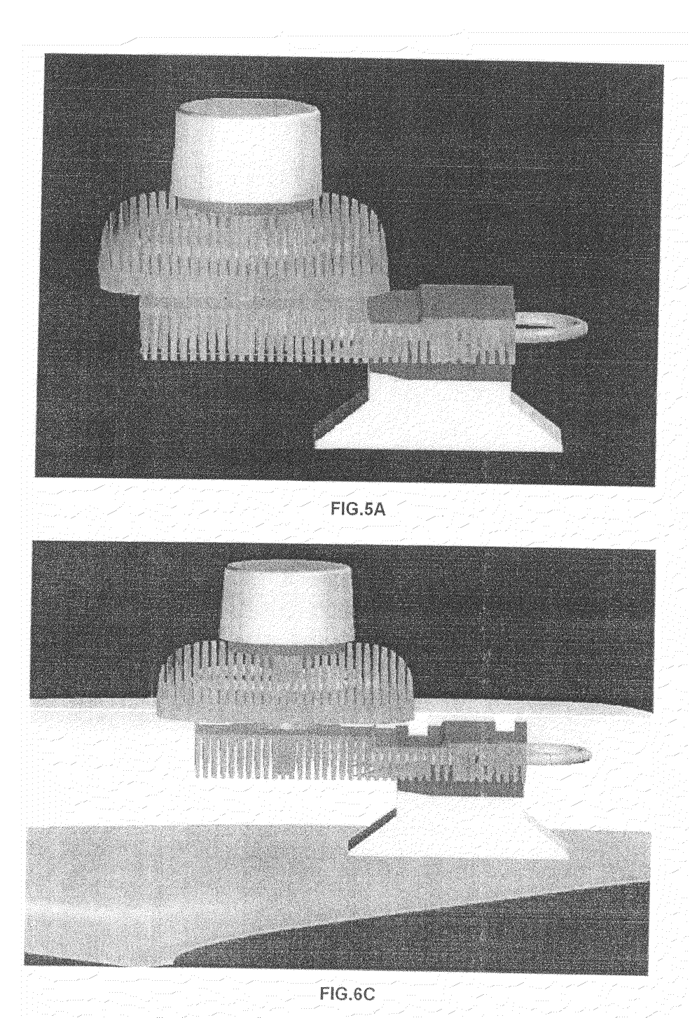

In assembled the invention to the opened hole (7) of luminaire as FIG. 6, which show upper and side of assembled luminaire. FIG. 6A, show assembled luminaire (5) by fin heat sink (12) as front direction of luminaire, and FIG. 6A, show assembled luminaire (5) by heat sink fins (12) as rear direction of luminaire. FIG. 7, FIG. 8, show assembled luminaire as direct strength heat pipes (11) passes opened channel and/or hole of luminaire (5).

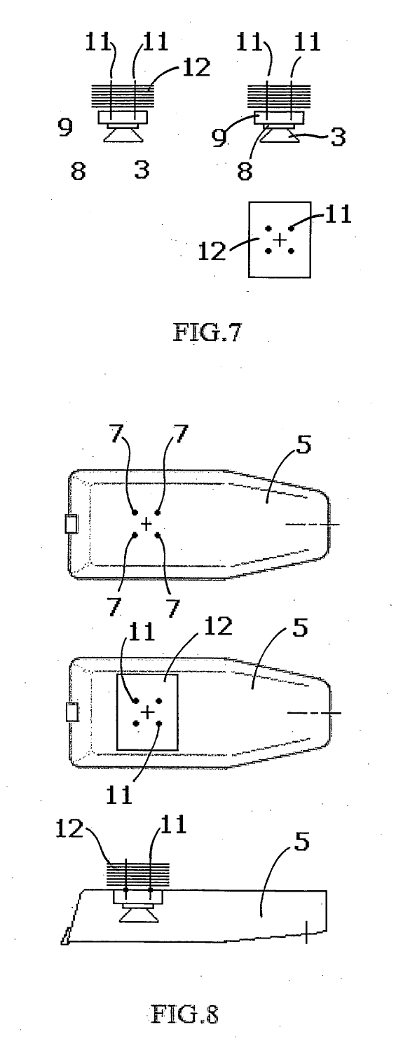

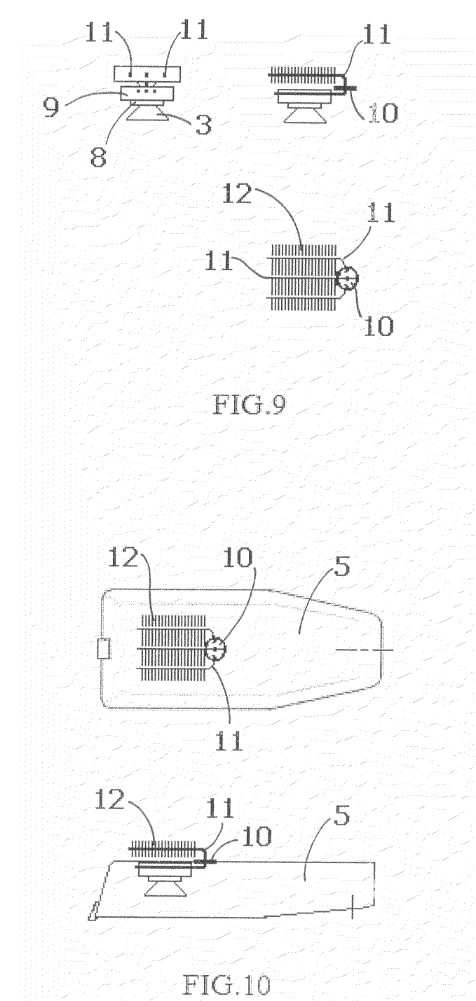

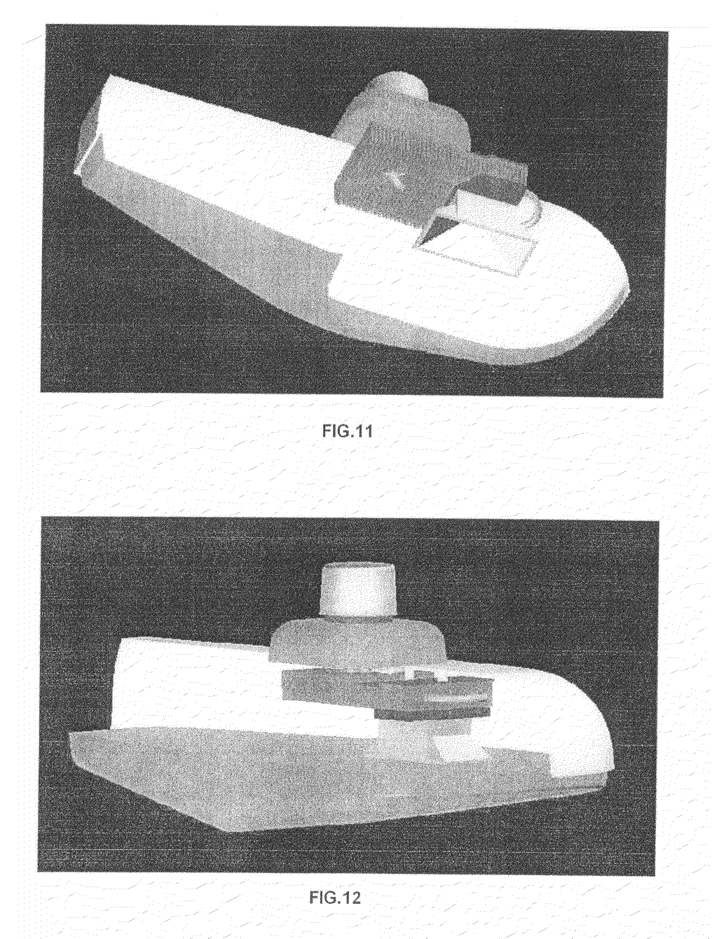

FIG. 9, FIG. 10, show assembled luminaire by bent the heat pipes (11) between heat absorber (9) and heat dissipative as heat sink fins (12). By FIG. I 0, show assembled the invention by bent the heat pipes (11) passes opened channel and/or hole (7) of luminaire (5).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1. An apparatus comprising:
a luminaire having upper and/or lower part which has an opened channel and/or hole and a solid state light emitting diode wherein the open channel and/or hole is used to pass heat pipes therethrough for dissipating heat from inside the luminaire to outside the luminaire;
a reflector disposed behind the solid state tight emitting diode for directing light emitted from the solid state light emitting diode to a particular location;
a heat absorber fabricated from copper and/or aluminum;
a fixed hole part;
a plurality of heat pipes fabricated from copper and/or aluminum inside pipe contained water, liquid, chemical, solid, and/or fined solid which the heat pipes is tube of long hole structure and cross section form as circle flat ellipse or rectangular; and
heat sink fins made from aluminum and/or copper,

2. The apparatus of claim 1, Luminaire of upper and/or lower which made opened channel and/or hole, closed luminaire is made new hole and/or made more holes of either upper or lower luminaire.

3. The apparatus of claim 1, opened channel and/or hole for passes heat pipes which made from cupper and/or aluminum in order to dissipative heat from inside to outside luminaire.

4. The apparatus of claim 1, Heat pipes made from cupper and/or aluminum inside contained water liquid chemical solid and/or fined solid which the heat pipes inside with open long hole and cross section with circle flat ellipse or rectangular consist of fixed hole part to opened hole luminaire which can bend heat pipes passes through opened hole of luminaire, heat pipe of the present invention have one pipe and/or more than one pipe passes through opened hole of luminaire.

5. The apparatus of claim 4, Heat pipes consist of fixed hole part to fix opened channel of luminaire which heat-in end direct fixed to heat absorber and heat-out end fixed to evaluation of heat sink fins.

6. The apparatus of claim 1, the present invention using for closed and/or opened luminaire, city street lighting luminaire, bridge for person across the road, road bridge, river bridge, express way, high way, and/or parking lot lighting luminaire, sport field, youth field, and/or luminaire for internal and external of office building, commercial, hospital, supermarket, and household, and/or lLiminaire for security system.
